(19) United States
(12) Patent Application Publication
(10) Pub. No.: US 2008/0198225 A1
(43) Pub. Date: Aug. 21, 2008

(54) TVMS- a total view monitoring system

(76) Inventors: Ehud Gal, Reut (IL); Gennadiy Berinsky, Modi'in (IL); Yaniv Nahum, Tel Aviv (IL)

Correspondence Address: FROMMER LAWRENCE & HAUG LLP, 745 FIFTH AVENUE, NEW YORK, NY, 10151, US

(21) Appl. No.: 11/999,618

(22) Filed: Dec. 6, 2007

(30) Foreign Application Priority Data
Dec. 7, 2006 (IL) 179930

(51) Int. Cl. H04N 7/18

(52) U.S. Cl. 348/143; 348/E07.085

(57) ABSTRACT

The present invention is a system for comprehensive observation and tracking of objects in distinct defined areas. This is implemented by the use of imaging sensors, comprising an electronic video camera and integrated processors, providing an overhead view of a pre determined sector during real time. The system also comprises a central processing unit (CPU) for managing all processed data, a display and managing unit which can be used for initializing, updating parameters and managing the system. The system supports means of communication between the imaging sensors and the central processing unit and between the central processing unit and the display and managing unit. The integrated processor of each of the sensors comprises 3 dimensional region of interest (3D ROI) software, which allows definition of a 3D-ROI to be imaged by each of the cameras and understanding of the spatial context of the features in the ROI, and software which allows extraction of data relevant to the identification, location and motion of objects in the ROI. The communication assembly allows transmission of the relevant data from each sensor to the central processing unit which uses it in order to enable continuous tracking of the moving objects as they pass from the field of view of one sensor into the field of view of a neighboring sensor, throughout the entire observation area. In combination with the 3D-ROI software allows clearly identifying the exact location of features of the room being observed e.g. floor, windows and doors of the room being observed, allows this understanding of the spatial context and allows the ability of the system to minimize the occurrences of false alerts (Ghosts).

### FIELD OF THE INVENTION

The present invention relates in general to the field of Electro Optics. In particular, the present invention relates to imaging and advanced digital image processing of data received from imaging sensors.

### BACKGROUND OF THE INVENTION

Today there are some observation systems containing omni directional view imaging sensors that are used for security. The following prior art describes systems with omni directional capabilities. These systems are used in many fields today.

Publication number WO 00/74018 by Korein describes an omni directional view imaging system with lighting means for suitable lighting of a region of interest in a way that can be controlled in order to receive a high quality image.

U.S. Pat. No. 5,790,181 by Chahl, describes a system for panoramic imaging of an open space according to certain parameters. The system is based on a convex mirror and a camera located in correspondence with the convex mirror.

U.S. Pat. No. 6,304,285 by Geng describes a half spherical mirror, a projector placed in correspondence with the mirror and a filter with a changing wave length enabling it to receive an image with the angle of 180 degrees.

U.S. Pat. No. 5,790,182 by St. Hilaire describes the use of two mirrors placed one in relation to the other in the “golden relation” enabling a spatial observation sector.

WO 02/059676 by Gal teaches about lenses with asymmetrical convex lenses to enable a peripheral observation sector.

WO 03/026272 by Gal describes lenses based on the use of both a symmetrical reflecting surface and an asymmetrical reflecting surface.

WO 02/075348 by Gal describes the use of an omni directional view lens for pinpointing and raising an angle to various sources, determining the elevation angle and location of sources of radiation of different kinds.

WO 04/042428 by Gal teaches the use of lenses that enable the acquisition of a peripheral image and simultaneously omni directional illumination of the sector observed through the lenses.

WO 04/008185 by Gal teaches the use of an optical system enabling omni directional view observation by means of an asymmetrical central lens and additional lenses corresponding to the central lens.

In addition to these publications there are techniques to produce a spatial image by the use of a number of directional cameras wherein every directional camera is directed to cover a certain sector in a way that all cameras together cover a wide sector up to 360 degrees. With this technique the obtained data from all the cameras can be displayed by an interface on a screen. The use of multiplexing processing integrals can improve the speed of obtaining data from the cameras and to select the amount of data obtained from each camera.

IL 177987 by Gal describes a smart sensor with capability for an omni directional observation. The sensor comprises means for digitally processing the image obtained and means for aiming the directional camera to the observation sector as needed. The sensor is used for monitoring activity at the area surrounding it. The sensor enables sending warning alerts according to a pre defined protocol. This smart sensor is the size of a baseball and is portable.

U.S. Pat. No. 6,629,028 by Paromtchik describes a system that sends lighting commands on a surface where driven objects are supposed to be driven. The light projected on the surface is received by visual imaging devices located on the driven objects. The driven objects process the data and analyze the driving commands necessary, in order to reach the lighted spot on the surface.

It is therefore an object of the present invention to provide a solution for observation and imaging of a selected sector, obtaining a “world view”, by the use of omni directional view imaging sensors.

It is a further object of the present invention to provide a system that enables smart data processing, with data received from the omni directional imaging sensors and enabling management of the data between the sensors.

It is yet another object of the present invention to provide a system for observation and imaging a three dimensional region of interest and includes a software program for digital image processing, displaying and/or storing it and filtering out false alerts.

It is yet another object of the present invention to provide a system that enables the operator of the system to observe the region of interest and control the system from a distance.

It is yet another object of the present invention to provide a system that enables transmitting visual data to the remotely operator in real time according to pre defined criterion.

It is yet another object of the present invention to provide a system comprising enabling sending specific warning alerts by means of a dedicated software for image understanding to enable sending specific warning alerts.

It is yet another object of the present invention to provide means for assisting the operator to make decisions and specifying the direction of objects.

Additional objects and advantages of the present invention will become apparent as the description proceeds.

### SUMMARY OF THE INVENTION

The present invention is a system for comprehensive observation and tracking of objects in defined areas. The system comprises:
A) Imaging sensors, comprising an electronic video camera and integrated processors. The sensors provide an overhead view of a pre determined sector during real time;
B) A central processing unit (CPU) for managing all processed data;
C) A display and managing unit which can be used for initializing, updating parameters and managing the system;
D) Communication assembly enabling communication between the imaging sensors and the central processing unit
E) Communication assembly enabling communication between the central processing unit and the display and managing unit
   wherein,

The integrated processor of each of the sensors comprises 3 dimensional region of interest (3D ROI) software, which allows definition of a 3D-ROI to be imaged by each of the cameras and understanding of the spatial context of the features of the ROI and software which allows extraction of data relevant to the identification, location and motion of objects in the ROI; camera and the communication assembly allows transmission of the relevant data to the central processing unit

The central processing unit receives the relevant data from all of the sensors and integrates it in order to enable continuous tracking of said moving objects as they pass from the field of view of one sensor into the field of view of a neighboring sensor (Hand shaking). In an embodiment of the invention the central processing unit comprises communication means adapted for communicating with a remote location. In another embodiment he central process unit can be an integrated part of the display and managing unit. In another embodiment CPU is a Set Top Box installation (STB), and can be connected to a TV.

The display and managing unit includes:
a) Receiving and transmitting means
b) A display screen
c) A software program
d) Input means

The system's display and managing unit communicates with the system by means of a wired or wireless communication network. The system enables communicate also by internet or by a cellular network. The display and managing unit can be comprised of one or more of the following items—a PC, a cell phone, a PDA or a portable compact display and managing unit. In an embodiment of the present invention the display and managing unit comprises communication means adapted for communicating with a remote location. In another embodiment the system enables the loading of a map of the observation area on the display and managing unit, and enables the operator to define regions and give commands with the aid of said map during real time.

In an embodiment of the present invention, the system comprises one or more directional cameras to enable production of a high resolution image of objects.

In another embodiment of the present invention, the imaging sensors comprise omni directional view optics.

In another embodiment of the present invention, the system comprises sensors and detectors which comprise alerts that are used to activate the cameras.

The system can be operated in a passive mode wherein an authorized operator manually controls monitoring of the observation area and the system can be operated in an active mode wherein the system automatically initiates and sends warning alerts according to pre defined criterions. The system can communicate with one or more of the following agencies and enables alerting them—a police station, a fire department, a private security service station, etc.

In an embodiment of the present invention, the system comprises lighting means compatible for the imaging sensors, for seeing in dark.

In another embodiment of the present invention, the system enables gathering of pre defined time and location data of the objects observed.

In another embodiment of the present invention, the system enables updating of its dedicated software programs.

In another embodiment of the present invention, the system enables transmission of commands to activate and direct objects. These objects may comprise a transmitter so that system can verify said object's location.

In another embodiment of the present invention, the system enables monitoring areas containing pet animals, and filtering out warning alerts caused by the animals. The system can comprise sound means for pet animal training if the pet animal enters a predefined out of animal range area.

In another embodiment of the present invention, the system is used to control the flow of traffic at road junctions.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates all major elements of the invention.

FIG. 2 illustrates a preferred embodiment of the present invention including an overhead view of a 3D-ROI.

FIG. 3 shows an embodiment of the present system that is implemented using several imaging sensors located in different rooms of a house

FIG. 4 schematically shows the display screen of the display and managing unit.

FIG. 5 schematically illustrates other embodiments of the present invention.

### DETAILED DESCRIPTION OF THE PREFERRED EMBODIMENTS

The present invention describes a system for comprehensive observation and tracking of objects in defined areas. The system comprises:
1) Omni directional view imaging sensors, comprising omni directional view optics and integrated processors.
2) A central processing unit for managing all processed data
3) A unit for interfacing, initializing, updating parameters and managing the system, from hereon known as a display and managing unit. The unit includes:
   a) A receiver
   b) A display screen
   c) A software program that among other functions enables designation of a three dimensional region of interest.
4) A communication assembly enabling two way communication with a remote location.

When the system is used for observation of a room then the imaging sensors are installed on the ceiling. Each imaging sensor is preferably placed about the center of the sector it is designated to cover. Installment on the ceiling enables each sensor to obtain a “world image” of what is occurring in its sector from an overhead view. The data obtained from the sensors is processed by an integrated processor located in the sensors. The processor enables Video Motion Detection (VMD) i.e. detection of objects in motion in the designated sector. The processor also enables object tracking i.e. determining the location of the objects and following their motion path route in the designated sector. In addition the processor enables determination of relevant characteristics for example the object's direction and speed, time spent in designated sector, meetings with suspicious people, unattended luggage, characteristics of the object such as the color of hair or clothes, or their size of all objects as desired by the operator. The acquired data is transferred to the central process unit.

The central process unit organizes the data sent to it by the imaging sensors, in order to enable coordination between them and continuous tracking of objects in motion when crossing from one sensor's observation sector to a nearby sensor's observation sector. An overlap between sectors is not necessarily but is highly recommended. The action of coordination between the sensors at object crossing time and continuous tracking of the whole motion path of the objects is known herein as “Hand Shaking”. The speed and direction of the object which is about to leave a sector is sent by the imaging sensor which covers that sector to the central process unit where the data is processed and from there the data is sent to the imaging sensor in the sector that the object is moving towards. The use of omni directional view imaging sensors installed from above in the center of the sector, makes hand shaking to be more easily performed. The ability of the system to perform hand shaking is especially useful when using many sensors and tracking many objects simultaneously. Practically, the efficiency of the invention enables the capability to activate many imaging sensors, and to track and analyze the characteristics of thousands of objects in motion simultaneously. The system accomplishes all this with relatively limited usage of computing power.

The system includes a display and managing unit. In addition, the system enables sending automatic warning signals according to profiles pre defined by the operator of the system. Such basic profiles to be defined are for instance Region of Interest (ROI), and Region of Non Interest (RONI). The ROI can be defined upon the omni directional view image in a graphic way. The ROIs are likely to contain additional information defined by the operator for instance the schedule and the sensitivity threshold required for activating observation of a specific ROI.

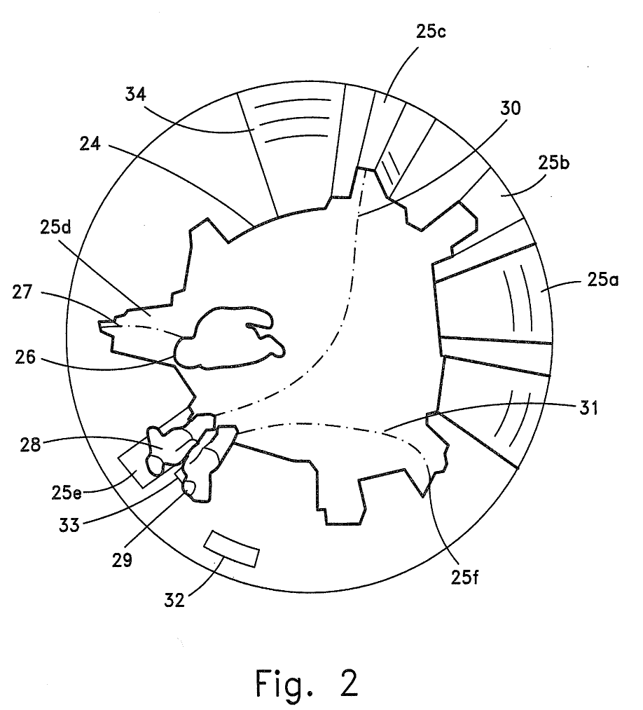

The present invention also enables the ability to define a three dimensional ROI in an omni directional view image, as will be described in FIG. 2 herein below. In combination with the 3D-ROI software allows clearly identifying the exact location of features of the room being observed e.g. floor, windows and doors of the room being observed, allows this understanding of the spatial context and allows the ability of the system to minimize the occurrences of false alerts (Ghosts). For example the separation of the floor from the rest of the image can be implemented manually by the operator or automatically by a software program for “image understanding”(IU). The IU software program enables separation of the pixels of the floor from the rest of the image according to pre defined. Since monitoring for example the image of a person walking in the room will show that his feet are in contact with the floor. This can be the criterion for which the system determines if the person is already present in the room or viewed through a window.

The Omni directional view imaging sensors are used as initiators for detecting and sending alerts. For instance if the system detects an object in motion by means of the VDM in a pre defined ROI (pre defined by the operator) where object motions are prohibited, the system sends automatically visual data of the object to the cellular phone of the operator and to a security service, defined by the operator, through the internet. Sending the smart alerts is done according to pre defined profiles. The alerts may also be sent to other locations as required such as to a PC, to the fire department, to the hospital etc.

Embodiments of the system comprise additional sensors and detectors incorporated, for instance a volume sensor, a smoke detector, a temperature detector, a carbon monoxide sensor, a dampness detector, light detector, a noise detector, a NBC detector (Nuclear, Biological, and Chemical), etc. These additional sensors and detectors are used for a number of purposes. Among them:
1) Saving Energy—These sensors are used for initializing the imaging sensors and integrated processor. For instance only when the volume sensor passes a pre defined level of noise, is the omni directional view imaging sensor activated in the relevant ROI. Otherwise the omni directional view imaging sensor is in “stand by” mode. This is a way to improve the system's consumption of energy.
2) Filter out false alerts—The data obtained by the sensors can be cross-checked by obtaining the imaging data from the sensors thus filtering out false alerts. For instance if the system is activated in an apartment house containing animal pets for instance a dog, a cat, a parrot, a fish, etc. When suspecting that the pets are the suspicious objects identified by the VMD in the imaging sensor, it is possible to improve the likelihood of the classification by cross-checking the data obtained from the volume sensor thus filtering out all motions of animal pets in the ROI. In a similar way it is possible to filter out alerts detected by the VMD of objects as being in the ROI, while in fact they are merely a reflection of objects through the window, outside of the ROI.
3) Sending specific alerts—When activating a specific sensor it is possible to send an alert directly to a relevant factor in order to improve the time response of these factors, and prevent disasters. For instance if the smoke detector and/or the temperature detector and/or the carbon monoxide detector are activated, it is possible to send an alert including visual data directly to the nearby fire department automatically. Another example is if the sound detector identifies voices in distress or voices calling for help, it is possible to directly send a warning alert with an image to the nearby police or private security service station pre defined by the operator of the system.

The system additionally allows the operator to connect to the system from a distance in order to see what is occurring in the ROI (a monitoring process). This can be done by use of a password, or other secure connection to the system. The communication can be by use of a Personal Digital Assistant (PDA), a cellular phone, Personal computers (PC) etc. After connecting to the system the operator can send necessary operating commands to the system in order to neutralize certain alerts etc.

The system is intended to enable omni directional view monitoring with the possibility of sending smart alerts to several factors in order to respond accordingly. The system can be used for observation and security in the private market—for use of apartments, houses, yachts, private jets etc. The system can be used in the commercial market—for several types of businesses for example stores, supermarkets, banks, malls, casinos, offices, etc, and in facilities such as prisons, military bases, etc. The system can be used in the civil market—security an monitoring train stations, bus stations, airports, museums, controlling junctions, security of infrastructures—water, electricity, etc. The ability to analyze an image of the system by means of a software program enables many options that can be used for managing, researching and analyzing behavior in a ROI.

In a preferred embodiment of the present invention the system enables the gathering of relevant information for managing and controlling needs. The system can be used in offices, businesses, stores, factories etc. The system can calculate the time of work of workers in a certain area and check how much time were they in their offices as opposed to the time that they were out of their offices. The system can also check the length of the lines that customers stand in, and the time they stand in the lines, with use of a software program that understands the images. This is useful for fast food restaurants, government office services, etc, with such information can be used to open other service lines. Alternatively, the only specified software program can be modified to enable the recording of motion of certain machines in factories for instance while instructing the system to ignore other objects.

The ability to observe i.e. detect and track objects and understand the spatial context by means of the 3D-ROI, gives the system advanced capabilities. For instance the system can direct motion of certain objects in the ROI. This feature is implemented, for example by sending commands from the system to a receiver upon the object. This type of directing can be used for several implementations, for example guiding blind people by sending commands to a receiver located in the blind person's ear, or directing a wheelchair, comprising a receiver that can receive driving commands for activating motors that drive the wheelchair. One can also activate a vacuum cleaner or a floor polisher in a pre defined course. The vacuum cleaner needs to have a receiver installed in it and a drive mechanism that enables execution of the received commands. Another implementation is to have an automatic guide in a museum. The museum visitors can be given a device with earphones. The system can read aloud explanations according to their location in the museum. Another implementation is to use robots that receive commands from the system to guide blind people or execute other commands in a defined area.

In a preferred embodiment of the present invention the system comprises a directional camera to enable production of a photograph which is a high resolution image of objects. The directional camera can be placed at any location in the observed area to fulfill the requirements of any system. At the time of entering the ROI a photo may be taken using either the directional camera or the omni directional view imaging sensor. An ID number is assigned to each object the first time it enters the observation area and is used by the system until the object exits the observation area. The operator can see this photo at any given time for identification of the object, in other words the identification is performed once when entering the ROI, the continuous tracking is done while using minimal processing and the high resolution image can be displayed by the operator when ever he wants. Using this method it is possible to track thousands of identified objects in the whole observation area with use of only a relatively limited amount of computer processing.

The implementation of the communication within the system between the imaging sensors and the central process unit and between the central process unit and other agencies can be implemented by means of a variety of methods. The communication can be digital or analog, encrypted or not, wireless or by wire, compressed or not, direct or through a third party, based on cellular infrastructure or based on the internet, etc. Other methods of communication are clear to a person skilled in the art therefore we will not elaborate all methods of implementation of communication in the system are not elaborated and the examples given are not to be seen as any restriction on the present invention.

In a preferred embodiment of the present invention the sensor includes a source of illumination whose properties are selected to be compatible with those of the imaging sensor. Such properties of the illumination include for example the wave length of the illumination according to the sensitivity of the imaging sensor, the volume of the region illuminated at least by field of view of the imaging sensor and other optical factors.

In a preferred embodiment of the present invention the system combines a number of operating modes. A passive mode that is used for monitoring by an operator located at a distant location. The operator can connect to the system by entering a password and will be able to monitor activity in all sectors covered by the system. The operator can monitor images from sector to sector and focus on relevant sectors. The operator can send commands for instance definition of a ROI, definition of a RONI, turning off the system, operation in a different mode etc.

The system allows an active mode. An active mode comprises automatic initiation of communication and sending warning signals and visual data to pre defined relevant factors according to pre defined criterions. For instance a warning alert to the fire department as explained herein. The operator can define the operation mode of the system at certain times, for instance the operator can define that during the day the system will be operated in a passive mode and at night the system will automatically changed to operate on an active mode until the morning.

In a preferred embodiment of the present invention the system enables interfacing with additional observation factors, for instance internet cameras, directional cameras that are likely to be used for observation of narrow places or for obtaining a high quality high resolution image of an object when entering a pre defined area. Also other types of cameras can be used according to the specific application.

In a preferred embodiment of the present invention the central process unit is an integrated part of the display and managing unit.

In a preferred embodiment of the present invention the central process unit can be a Set Top Box (STP) enabling interface with a television (placed near the cable converter). Connection of the system to a television enables use of the television for means of observation and an interface for operating the system by a TV remote control.

In a preferred embodiment of the present invention the software program can be upgraded or improved, by adding specific software program packages compatible with the operator's needs. An optional software program packages can adapt the system to work for instance when a pet animal is in the ROI, or can determine average length of lines in supermarkets.

In a preferred embodiment of the present invention the system includes an algorithm that is based on the ability to separate between the floor and the walls in order to process data obtained from an overhead image and display it to the operator as if he were viewing the region from floor level. This feature is similar to that used in computer games.

In a preferred embodiment of the present invention certain pre defined objects can be equipped with transmission means to notify the system when they enter a ROI and to activate the specialized software instructions related to the activity of that object in the ROI. This embodiment can be used for the smart vacuum cleaner, robots, wheelchairs, museum visitors and pet animals. In addition this software program can be used to track prisoners or patients in closed wings, etc.

In a preferred embodiment of the present invention the omni directional view imaging sensors can be installed on posts at traffic junctions. The system includes a unique software program that understands the events occurring at the junction such that the software program enables distinguishing between pedestrians and vehicles thus it is possible to gather relevant information enabling efficient management of the junction, either automatically or by sending recommendations to the operator in a control room. This system capability is called a Decision Support System.

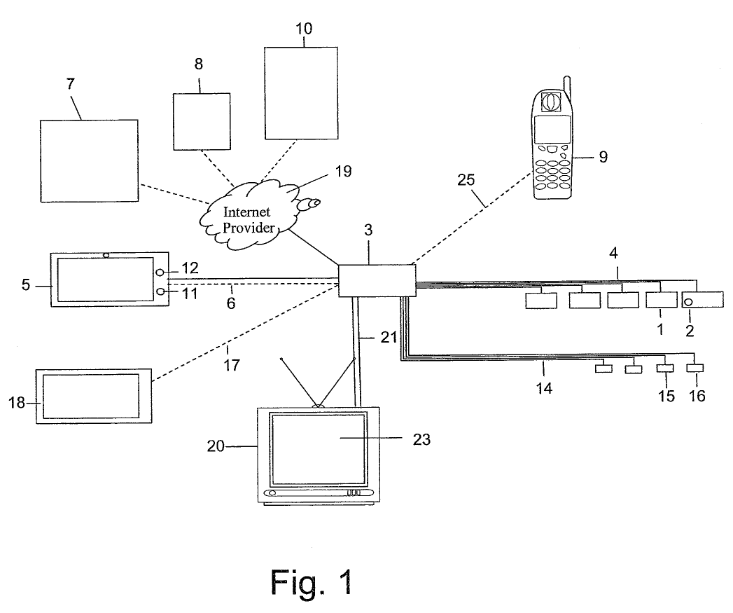

In a preferred embodiment of the present invention the system is composed of a number of elements. FIG. 1 schematically illustrates all major elements of the invention. It is to be noted that the system used in specific applicants may not be comprised of all of the elements showing in FIG. 1. The system is composed of all view imaging sensors (1). These sensors comprise a video camera and optics design for spatial observation. These sensors may be equipped with illumination means (2) which can be manually activated or activated automatically by means of a light level sensor. The illumination means can be provided with light source for supplementing with visible light or with a source producing illumination in the NIR (Near Infra Red), for observing in the dark. Each imaging sensor sends gathered data to a CPU (3) by a communication network (4), The communication network can be a wireless system, a wired internet communication method, telephone lines or any other communication method. The data arriving at the CPU (3) is managed to coordinate between the sensors to maintain continuity of tracking the objects, detecting a general direction of object's motion and for saving relevant data in the system's memory for later use.

The CPU (3) is preferably located near the observation area, taking into consideration factors such as communication with the image sensors, installation comfort and security factors e.g. hiding the system elements from hostile factors trying to sabotage the system.

A display and managing unit (5) can be installed permanently in a convenient location e.g. in the lobby of an office building, or a portable compact display and managing unit (18) can be provided. The communication (6) between the display and managing unit (5) and the CPU (3) can be based on a wire communication network or a wireless communication network. The communication to wireless portable unit (18) is preferably by means of a wireless network (17). There can be a docking station for the portable compact display and managing unit (18), to facilitate frequent movement of the display and managing unit (5) between a number of fixed locations.

Monitoring from a distance can be implemented by means of a dedicated display and managing unit (5) as described or alternatively by means of other devices such as PC (7), a PDA (8) by means of internet provider (19) or by a cellular phone (9) by cellular network (25) The system can operate in a number of modes as explained herein above. When the system operates in an active security mode it can send warning alerts to a security service station (10) by means of the internet provider (19). The operator can change modes on the display and managing unit (5) by use of input means such as a touch screen. The operator can know the current operating mode by means of indicators (11), for a monitoring mode and (12) for the security mode. The display and managing unit (5) may enable recording of video messages, operation of video reminders pre made by the system, a video answering machine, etc.

In some embodiments the CPU (3) is a Set Top Box installation (STB), which can be connected to a TV (20) by means of a video-in/video-out connection (21). The operator can watch TV and when a warning alert is received, a visual image of the ROI pops up on the screen (23).

The system includes additional sensors and detectors for example carbon monoxide sensor (15) or the volume detector (16) which can be integrated with the image sensors or can be separate elements connected directly by connection means (14) directly to the CPU (3). Connection means (14) can be any of the types described in respect to connection means (4).

In a preferred embodiment of the present invention the optics of the omni directional view imaging sensors is based on a standard Fish-Eye lens which allows 3D-ROI observation. Separation of the floor from the walls can be done automatically by an algorithm that interprets the image parameters by identifying the angle between the horizontal floor and the vertical walls and also observing their different colors. The operator can also mark the floor on the images manually. After the outline of the floor is marked on the image a ROI is identified near each of the entrance doors (25a, 25b, 25c, 25d, 25e, 25f) (see FIG. 2). The operator defines by inputting to the managing and displaying unit (5, 18) the rules for operating the system. For example the rule might be that every entrance to the room after 7:00 pm will cause the system to send an image of the entering object to the operator's cell phone. Each imaging sensor comprises an integrated processor with VMD capability and Object tracking capabilities, for example when person (26) enters through door (25d) then the system will track his motion (27) in his sector on the image. When person (26) leaves the ROI of the imaging sensor that first detects his presents in the room, it will deliver the necessary data to the CPU (3) to allow continuing tracking by another sensor. It can be seen in FIG. 2 that real moving objects 26, 27, 29 are connected to the floor, and their motion paths (27), (30) and (31) respectively can be traced on the floor. On the other hand apparent motion of objects in the image resulting from motion of objects that takes place for example from motion on the TV screen (32), computer screen (33) or object motions viewed trough the window (34) are not connected to the floor of the room and therefore the system will decide that they are false alert ghosts and should be filtered out (and ignored).

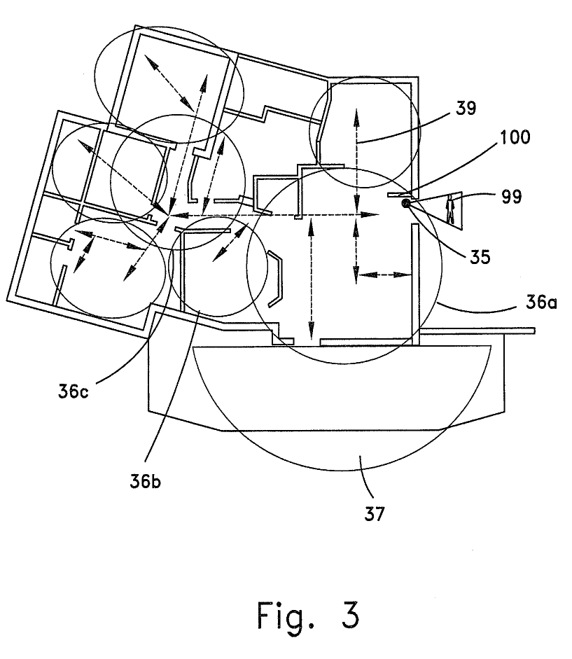

FIG. 3 shows an embodiment of the present system that is implemented using several imaging sensors located in different rooms of the house. A number of circular or elliptical ROIs are shown on the floor plan of the house. The sensors are installed on the ceiling graphically at the center of each sector. There is an overlap between sectors that makes the Hand Shaking tracking process easier, but this is not essential because the Hand Shaking process can occur between two neighboring sensors even without an overlapping area, by means of calculation of motion data, object's size or color, etc.

In some embodiments omni directional view imaging sensor has an integrated processor e.g. a Da-Vinci processor. The processor activates the VMD to find objects in motion and track objects in motion and to gather data of the object's direction, speed, motion path, size, color, etc. The relevant parameters are sent to the CPU (3) which receives data from all the sensors in the observation area, and coordinates between the nearby sensors when the object crosses from one sensor to a neighbor sector (Hand Shaking); thereby tracking the continuous path of objects in the observation site. Saving of energy, communication, and processing is based on the use of a combination of the following techniques
1) The use of omni directional overhead observation enables the locating of the objects in a given spatial area, and coordination between sensors when objects move from one sector to another. This is a great advantage over using directional cameras wherein is difficult to understand the exact location of the object, and many times more difficult to coordinate between directional cameras when objects move from one sector to another.
2) The use of a processor integrated in each imaging sensor allows transferal of only relevant data to the CPU (3).
3) The CPU (3) coordinates between sensors at time of object tracking and the managing of the required data sent from each sensor.

The combination of these 3 techniques enables capability for locating, tracking, producing a total motion path in the observation area and storing the relevant data for up to thousands of objects simultaneously, with a relatively minimal use of computation power.

In some embodiments the system enables combination of data from other standard sensors like a directional camera (35) located near the entrance door. In this case when an object enters the door the directional camera takes a high quality, high resolution picture. At the same time the object is located and tracked by the omni directional view imaging sensor which assigns the object an internal ID number associated with the picture taken by the directional camera. The continuation of tracking is done by using minimal characteristics of the object by the integrated processor in the sensor and by the CPU, even during crossing over from one sector to another. A remotely located operator can monitor a dot moving within the observation area. If he wants he can see the high resolution picture by entering a command on the display and managing unit (5). Note that the region of interest does not have to be circular but can have other shapes such that of sector (37).

The handshaking object tracking process can be understood with reference to FIG. 3. In this figure the observation area is a house comprised of a number of rooms. In each room a sensor of the invention is installed on the ceiling approximately in the middle of the room. Each of the integrated processors of each of the sensors comprises software that enables definition of a 3D-ROI to be imaged by the sensor's camera. Examples of such 3D-ROIs are sectors 36a, 36b and 36c shown in FIG. 3.

A man (99) enters the room inside 3D-ROI (36a) from the entrance door (100). His picture is taken by the directional camera (35) and the system gives him an ID number. When entering he is tracked by the first sensor 3D-ROI (36a). When man (99) approaches the second room [3D-ROI (36b)] the first imaging sensor sends data to the CPU (3) informing the CPU (3) that man (99) is about to leave 3D-ROI (36a) and cross into the neighboring 3D-ROI (36b). The CPU sends the data informing the second imaging sensor located in the second room that man (99) during his stay in 3D-ROI (36b). The second sensor tracks man (99) when entering his 3D-ROI (36b). When man (99) approaches the third room [3D-ROI (36c)] the second imaging sensor sends data to the CPU (3) informing the CPU (3) that man (99) is about to leave 3D-ROI (36b) and cross into the neighboring 3D-ROI (36c). The CPU sends the data informing the third imaging sensor located in the third room that man (99) is about to enter his 3D-ROI (36c). The third sensor tracks man (99) during his stay in 3D-ROI (36c), and so on and so forth. The continuous tracking continues on as long as man (99) is located in the observation area.

In FIG. 3 is demonstrated how paths (39) can be marked on the display and managing unit, for directing motored objects, such as a vacuum cleaner, a motored wheel chair, etc.

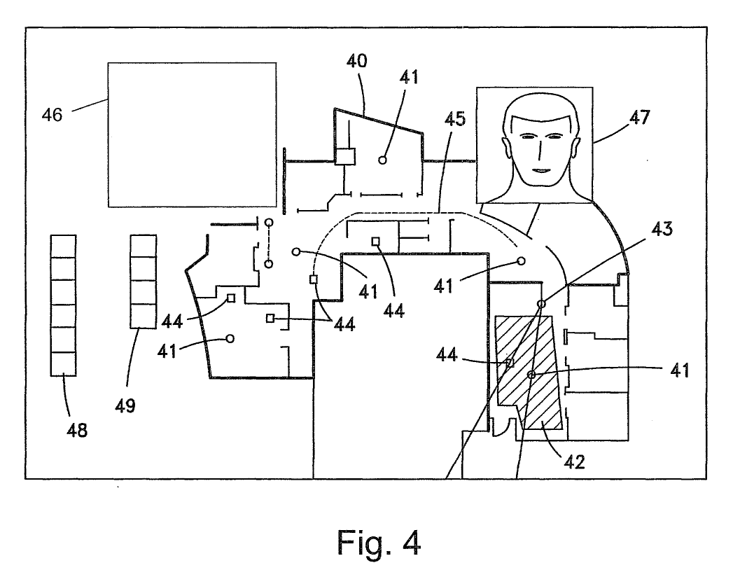

FIG. 4 schematically shows the display screen of the display and managing unit. The edge of the observation area (40) is marked by dark lines. A map of the observation area is pre loaded into the display and managing unit of the system. On the display and managing unit, the map is shown with the location of imaging sensors (41) marked, located at the center of the sectors. The operator marks the boundaries of the wanted ROI (42). A sensor with a directional camera (43) has been placed near one of the entrances to ROI (42). When an object enters the ROI the directional camera sensor takes a high quality, high resolution picture. At the same time the object is located and tracked by the omni directional view imaging sensors (41). Each object (44) is shown on the display and managing unit graphically as a square identified by the internal ID number. In this way many objects can be shown simultaneously tracked using a relatively low level processing capability.

When the operator chooses to focus on the activity of a suspicious object he can do so merely by clicking on the graphic marking of the object to see his motion path route (45), its current location and what he is currently doing in window (46) that opens on the display and managing unit, in real time. The operator can also open another window (47) where he can see the high resolution picture taken by the directional camera when the object entered the area. Tool bars (48, 49) on the display and managing unit assist the operator to manage the system.

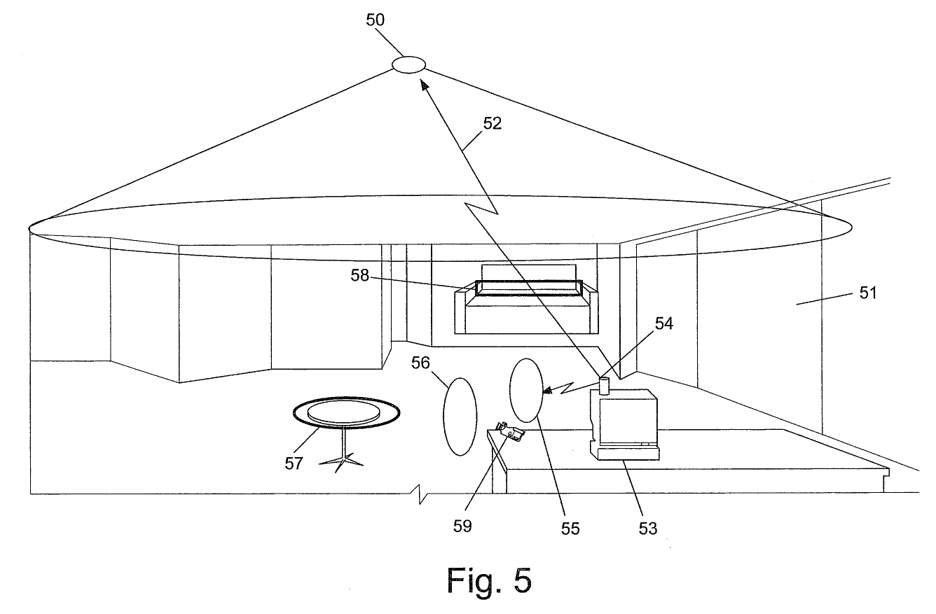

FIG. 5 schematically illustrates other embodiments of the present invention. In FIG. 5 is shown an omni directional view imaging sensor (50) placed at the center of the observation area on the ceiling. The 3D-ROI defines by the operator on his display and managing unit enables the system to filter out false alerts like reflections from the window (51).

The relevant data obtained from the imaging sensor is wirelessly transmitted (52) to the CPU (53) which includes a wireless transceiver (54) that can transmit orders to a robot vacuum cleaner (55). The vacuum cleaner (55) includes a transmitter for verifying its location, by the CPU in case the system looses track of it. The commands are sent from the CPU to the vacuum cleaner's receiver and from there to activate the vacuum cleaner. The operator marks the rug on his display and managing unit and specifies the desired time he wants to activate the vacuum cleaner, thus the system can activate it automatically.

The system enables an active mode in the defined area even when pet animals (56) are present in the defined area. The system can filter out warning alerts resulted by the pet animals (56). The filtering process can be done with the use of volume sensors with higher noise thresholds, and that are not activated by small animals. This can be implemented by means of a software program that examines the unique parameters of the pet animals for instance color, size, skeleton (that is horizontal as apposed to a person's skeleton which is vertical) and other parameters and combination of the parameters. When these unique parameters are detected by the system, the system filters out warning signals resulted by the presents of the animals in the defined area. It is also possible to allow the owners to monitor the defined area where the animals are present.

The system can be also used for training and controlling pet animals (56). The system enables smart warning signals specially relevant to the pet animals, for instance activating a noise unit (59) in a low frequency that can be heard only by the animals, or sounding the pre recorded voices of the owners of the animals on an audio storage device, every time they enter a pre defined out of animal limit area, like a couch (58) or on a table (57). These areas can be marked by the operator on the display and managing unit.

While some embodiments of the invention have been described by way of illustration, it will be apparent that the invention can be carried into practice with many modifications, variations and adaptations, and with the use of numerous equivalents or alternative solutions that are within the ability of persons skilled in the art, without exceeding the scope of the claims.

What is claimed is:

1. A system for comprehensive observation and tracking of objects in defined areas, comprising:
A) imaging sensors, comprising an electronic video camera and integrated processors; said sensors providing an overhead view of a pre-determined sector during real time;
B) a central processing unit (CPU) for managing all processed data;
C) a display and managing unit for initializing, updating parameters and managing the system;
D) a communication assembly enabling communication between said imaging sensors and said central processing unit
E) a communication assembly enabling communication between said central processing unit and said display and managing unit, wherein,
a) said integrated processor of each of said sensors comprises 3-dimensional region of interest (3D ROI) software, which allows definition of a 3D-ROI to be imaged by each of said cameras and understanding of the spatial context of the features in the ROI, and software which allows extraction of data relevant to the identification, location and motion of objects in the ROI; and said communication assembly allows transmission of said relevant data to said central processing unit
b) said central processing unit receives said relevant data from all of said sensors and integrates it in order to enable continuous tracking of said moving objects as they pass from the field of view of one sensor into the field of view of a neighboring sensor.

2. A system according to claim 1, wherein the display and managing unit includes:
a) receiving and transmitting means
b) a display screen
c) a software program and
d) input means

3. A system according to claim 1, which comprises one or more directional cameras to enable production of a high resolution image of objects.

4. A system according to claim 1, wherein the imaging sensors comprise omni directional view optics.

5. A system according to claim 1, including sensors and detectors which comprise alerts that are used to activate the cameras.

6. A system according to claim 1, wherein the display and managing unit communicate with the system by means of one or more of the following:
A) a wired communication network
B) a wireless communication network
C) internet
D) a cellular network.

7. A system according to claim 1, wherein the system communicates with one or more of the following agencies and enables alerting them:
A) police station
B) fire department
C) private security service station.

8. A system according to claim 1, wherein the display and managing unit is comprised of one or more of the following:
A) a PC
B) a cell phone
C) a PDA
D) a portable compact display and managing unit.

9. A system according to claim 1, wherein the central processing unit comprises communication means adapted for communicating with a remote location.

10. A system according to claim 1, wherein the display and managing unit comprises communication means adapted for communicating with a remote location.

11. A system according to claim 1, operative in a passive mode wherein an authorized operator manually controls monitoring of an observation area.

12. A system according to claim 1, operative in an active mode wherein the system automatically initiates and sends warning alerts according to pre-defined criteria.

13. A system according to claim 1, including lighting means compatible for the imaging sensors, for seeing in dark.

14. A system according to claim 1, wherein the system enables gathering of pre-defined time and location data of the objects observed.

15. A system according to claim 1, wherein the central processing unit is an integrated part of the display and managing unit.

16. A system according to claim 1, wherein the CPU is a Set Top Box installation (STB), and connectable to a TV.

17. A system according to claim 1, wherein the system enables updating of its dedicated software programs.

18. A system according to claim 1, wherein the system enables transmission of commands to activate and direct objects.

19. A system according to claim 1, wherein the system enables monitoring areas containing pet animals, and filters out warning alerts caused by the animals.

20. A system according to claim 19, comprising sound means for pet animal training if said pet animal enters a predefined out-of-animal range area.

21. A system according to claim 1, wherein objects in an observation area comprise a transmitter so that said system can verify said object's location.

22. A system according to claim 1, wherein the system is used to control traffic flow at road junctions.

23. A system according to claim 1, wherein the system enables loading of a map of an observation area on the display and managing unit, and enables an operator to define regions and give commands with the aid of said map during real time.
